(19) United States
(12) Patent Application Publication
(10) Pub. No.: US 2026/0024796 A1
(43) Pub. Date: Jan. 22, 2026

(54) MODULE STRUCTURE FOR FUEL CELL STACK AND FUEL CELL STACK HAVING THE SAME

(71) Applicant: UNIVERSITY OF SEOUL INDUSTRY COOPERATION FOUNDATION, Seoul (KR)

(72) Inventors: Young Seung NA, Seoul (KR); Cho Eun KIM, Seoul (KR)

(73) Assignee: UNIVERSITY OF SEOUL INDUSTRY COOPERATION FOUNDATION, Seoul (KR)

(21) Appl. No.: 19/233,346

(22) Filed: Jun. 10, 2025

(30) Foreign Application Priority Data
Jul. 22, 2024 (KR) 10-2024-0096101

(51) Int. Cl. H01M 8/2475; H01M 8/1004; H01M 8/241

(52) U.S. Cl. CPC H01M 8/2475; H01M 8/1004; H01M 8/241

(57) ABSTRACT

The present invention aims to solve the aforementioned problems by providing a structure that allows for the easy removal and replacement of only specific cells within a fuel cell stack, and ensures that each cell can be self-aligned during this process. The present invention is characterized by modularizing fuel cell stacks by grouping cells into bundles. Specifically, the structure comprises: a cell bundle (110) in which multiple fuel cell cells are stacked; an upper plate (120) and a lower plate (130) positioned above and below the cell bundle, respectively; and side coupling members (140, 150) attached to both sides of the upper and lower plates.

### CROSS-REFERENCE TO RELATED APPLICATION

This application claims priority to Korean Patent Application No. 10-2024-0096101, filed in the Korean Intellectual Property Office on Jul. 22, 2024, the entire contents of which are hereby incorporated by reference.

### TECHNICAL FIELD

This invention relates to the structure of modules, which are stacked vertically as part of an entire fuel cell stack, as well as to the overall stack formed by stacking these module structures. When assembling and disassembling the entire stack, the multiple modules can self-align, making disassembly and reassembly easy. Additionally, this fuel cell stack structure offers advantages such as reduced electrical resistance.

### BACKGROUND ART

Fuel cells are devices that generate electricity through the electrochemical reaction of hydrogen and oxygen, producing water as a byproduct. Recently, they have found applications in various fields such as power sources for zero-emission vehicles, residential power generation, and portable power systems.

A typical fuel cell stack consists of multiple fuel cell units (cells) located between end plates at each end. Usually, dozens or even hundreds of fuel cells are stacked to form a complete fuel cell stack.

At the core of a fuel cell is the Membrane Electrode Assembly (MEA), the main component located at the center. The MEA comprises a solid polymer electrolyte membrane that allows the transfer of protons (hydrogen ions), and catalyst layers applied on both sides of the membrane, which serve as the cathode and anode to facilitate the reaction between hydrogen and oxygen.

Outside the MEA, the cathode and anode sides are covered with gas diffusion layers (GDLs), gaskets, and other components. Beyond the GDLs, bipolar plates (or separators) are placed, which contain flow channels for supplying fuel and discharging the water generated by the electrochemical reactions.

In operation, hydrogen is oxidized at the anode to produce protons and electrons. The protons move through the electrolyte membrane while the electrons flow through an external circuit to the cathode. At the cathode, the protons and electrons react with oxygen from the air to produce water. The flow of electrons during this process generates electrical energy.

In a fuel cell stack, dozens or hundreds of fuel cells are stacked together. During the manufacturing process, issues such as quality defects or performance degradation may arise in some cells. In such cases, it may be necessary to replace only the faulty cells. However, this requires disassembling and reassembling the entire fuel cell stack. During this process, the alignment of the stacked cells can be disrupted, making reassembly difficult. In conventional fuel cell stacks, it is particularly challenging to isolate and replace only the problematic cells.

### SUMMARY

The present invention aims to solve the aforementioned problems by providing a structure that allows for the easy removal and replacement of only specific cells within a fuel cell stack, and ensures that each cell can be self-aligned during this process.

The present invention is characterized by modularizing fuel cell stacks by grouping cells into bundles. Specifically, the structure comprises: a cell bundle 110 in which multiple fuel cell cells are stacked; an upper plate 120 and a lower plate 130 positioned above and below the cell bundle, respectively; and side coupling members 140, 150 attached to both sides of the upper and lower plates.

Through the coupling of these side members, the upper plate, lower plate, the cell bundle positioned between them, and the side coupling members together form a single module. This allows the fuel cell stack to be disassembled and reassembled on a per-module basis.

The side coupling members include: end coupling grooves 152, 153 located at the upper ends to engage with both sides of the upper plate, and a central coupling groove 155 located at the lower center to engage with the central portion of the side of the lower plate.

Because the side coupling members firmly hold the upper and lower plates from the sides, this structure also helps restrain the expansion of the fuel cells.

A first projection-recess portion is formed on the top surface of the upper plate 120, and a second projection-recess portion that corresponds and interlocks with the first is formed on the bottom surface of the lower plate 130. When the module structures are stacked vertically, these interlocking structures help align the upper and lower plates precisely.

The upper plate 120 is composed of two separate parts 120-1, 120-2 forming a spaced region 120-3, while the lower plate 130 is positioned to correspond to the spaced region of the upper plate. When modules are vertically stacked, the lower plate interlocks with the spaced region of the upper plate to achieve alignment.

The upper and lower plates are conductive plates, and each fuel cell within the cell bundle comprises an MEA (Membrane Electrode Assembly), gas diffusion layer, gasket, and separator. Additionally, the present invention provides a fuel cell stack that includes this modular structure.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a perspective view of the entire fuel cell stack according to the present invention.

FIG. 2 is a perspective view showing an example of a modular structure constituting the fuel cell stack, with three modules stacked.

FIG. 3 is a bottom perspective view of the structure shown in FIG. 2.

FIG. 4 shows the modular structure illustrated in FIG. 2 being sequentially separated.

FIGS. 5 to 7 are individual perspective views of the components forming the modular structure according to the present invention.

FIG. 8 is a side view of the structure shown in FIG. 2, showing the unit modules aligned and stacked vertically.

FIG. 9 is a variation of the modular structure constituting the fuel cell stack according to the present invention, in which a specific pattern is formed.

FIGS. 10 to 13 show another embodiment of the present invention, in which the modular structure of the fuel cell stack features separated upper and lower plates.

### DETAILED DESCRIPTION

The objectives, specific advantages and novel features of the present disclosure will become more apparent from the following detailed description and the preferred embodiments, which are associated with the accompanying drawings. In addition, terms described herein are terms defined in consideration of functions in the present invention, which may vary according to the intention or convention of a user or an operator. Therefore, definitions of these terms should be made based on the contents throughout the present specification.

The fuel cell stack of the present invention is composed of unit modules, and its most notable feature is that when a defect occurs in certain cells, only the defective unit module can be repaired or replaced by loosening the bolts of the entire stack. The following description will focus on this aspect.

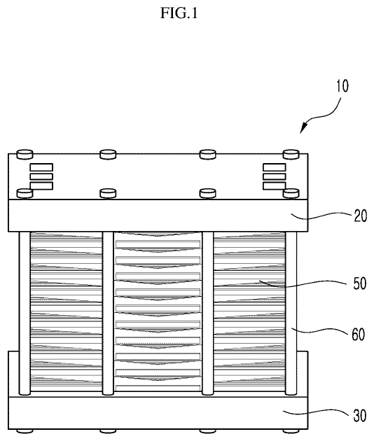

Referring to FIG. 1, the fuel cell stack 10 of the present invention includes end plates 20 and 30 located at the top and bottom, and a fuel cell structure 50, consisting of several dozen to several hundred fuel cell units, is positioned between them. The end plates are fastened using bolts 60. In this invention, the fuel cell structure 50 is not a simple stack of cells, but a set of fuel cell units integrated into a modular structure—hereinafter referred to as “unit module 100”—with several such modules stacked to form the complete fuel cell structure 50.

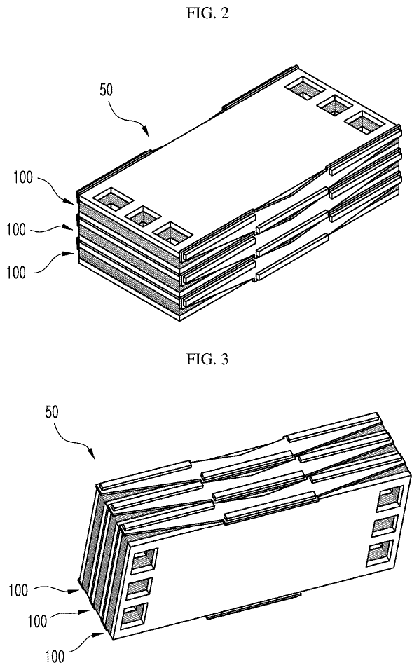

FIGS. 2 and 3 show three unit modules 100 stacked to form the fuel cell structure of the present invention. Typically, dozens of such unit modules are stacked to complete the fuel cell stack.

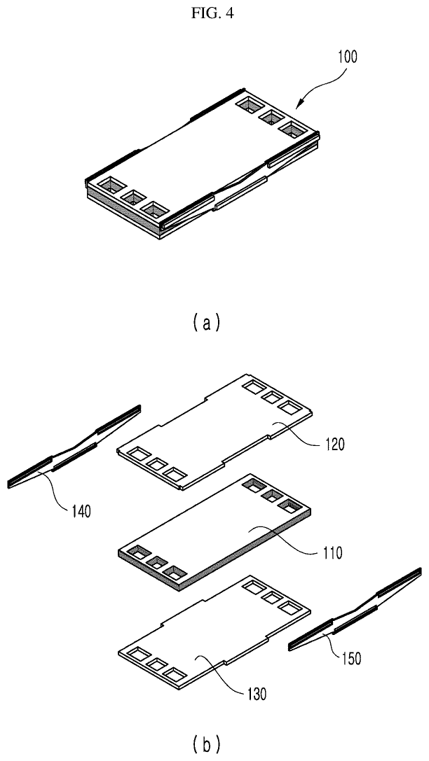

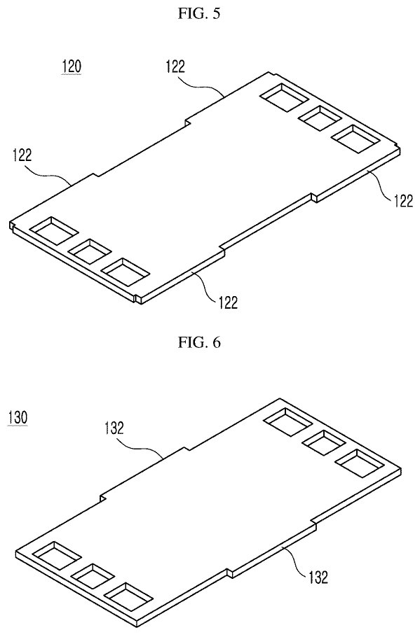

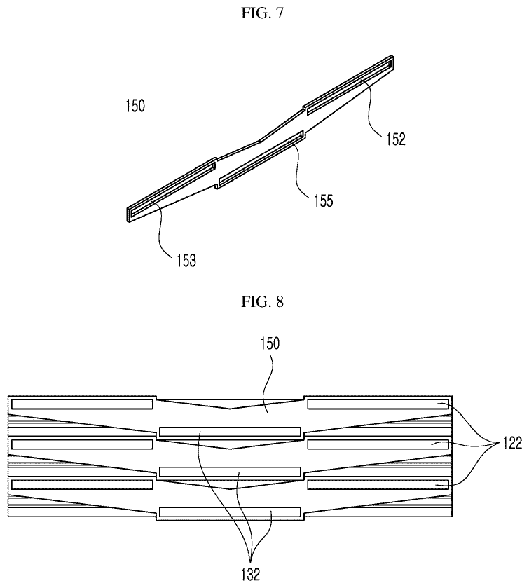

FIG. 4 illustrates the modular structure being disassembled sequentially, with (a) showing one unit module 100, and (b) showing an exploded view of its individual components.

Each unit module 100 consists of a cell bundle 110 where multiple fuel cells are stacked, an upper plate 120 and a lower plate 130 positioned above and below the bundle, and two side coupling members 140 and 150 that join the upper and lower plates on both sides.

Through the connection of the side coupling members, the upper plate, lower plate, the cell bundle between them, and the side members are integrally combined to form a unit module 100. This enables disassembly and reassembly of the fuel cell stack by individual modules.

The upper and lower plates are made of conductive material. The cell bundle 110 consists of a group of fuel cells—typically ten in this example. Each fuel cell comprises an MEA (Membrane Electrode Assembly), gas diffusion layer, gasket, and separator, which are standard components and will not be described in detail.

In the present invention, the unit module 100 is assembled by the two side coupling members 150 located on both sides. For this, each side coupling member includes: end coupling grooves 152 and 153 at the top ends, which engage with both sides of the upper plate, and a central coupling groove 155 at the bottom center, which engages with the center of the lower plate. The upper plate 120 has end coupling protrusions 122 corresponding to grooves 152 and 153, and the lower plate 130 has a central coupling protrusion 132 that fits into groove 155.

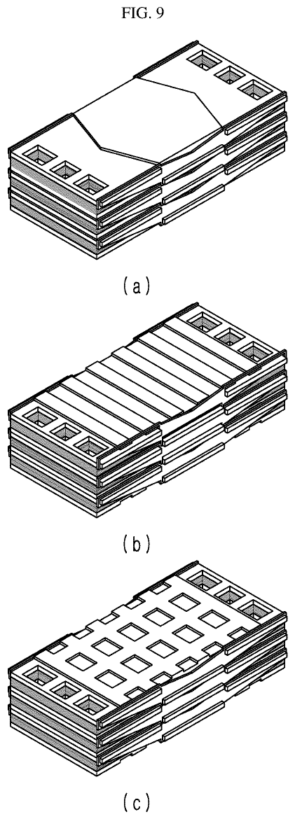

Terms such as upper, lower, central, and ends are used for explanation and do not limit the direction. In other words, any structure in which the side coupling member 150 connects the upper and lower plates is possible. For example, the lower plate's ends could also be connected to the side member via grooves and protrusions. FIG. 8 shows a side view of three unit modules 100 stacked.

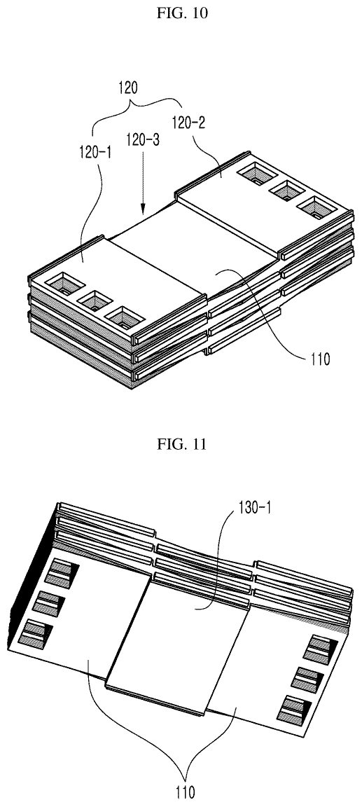

FIG. 9 illustrates a variation of the modular structure of the fuel cell stack. In this variation, specific patterns are formed on the upper plate 120 and lower plate 130. These patterns help guide and align the modules when stacked vertically and prevent them from shifting after alignment.

Specifically, a first protrusion-and-recess pattern is formed on the top surface of the upper plate 120, and a second protrusion-and-recess pattern corresponding to the first protrusion-and- recess pattern is formed on the bottom of the lower plate 130. When modules are vertically stacked, these interlocking shapes ensure automatic alignment between the upper and lower modules.

These protrusion-and-recess patterns (first and second) are not limited to a specific shape. As shown in FIG. 9, examples include: (a) polygonal groove shapes, (b) regularly spaced groove patterns, or (c) grooves spaced at consistent intervals. Any structure that enables interlocking alignment between the upper and lower plates is acceptable.

FIGS. 10 and 11 show another embodiment of the modular structure of the fuel cell stack. In this embodiment, three unit modules are stacked, and perspective and bottom views are provided. This example demonstrates that the upper and lower plates may not be a single continuous plate but may be separated.

Even in this embodiment, the unit module 100 still comprises a cell bundle 110, upper and lower plates 120 and 130 positioned above and below the bundle, and two side coupling members 150 that join the plates from both sides-just as described above. The only difference lies in the shape of the upper and lower plates.

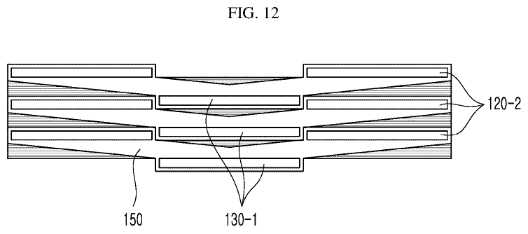

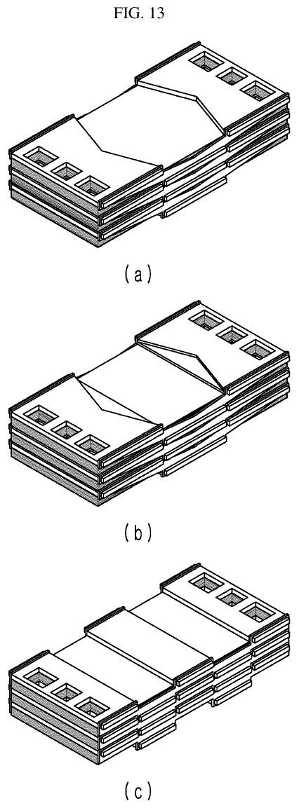

As shown in FIGS. 10 and 11, the upper plate 120 is divided into two separate upper sub-plates 120-1 and 120-2, which form a spaced region 120-3. The lower plate 130 is positioned to correspond to this spaced region 120-3 of the upper sub-plates. FIG. 12 provides a side view of the stacked structure in this embodiment. It shows how the unit modules 100 are stacked vertically, with the lower plate fitting into the spaced region of the upper plate, allowing for automatic alignment between the upper and lower modules during stacking.

The split configuration of the upper and lower plates is not limited to a specific shape. FIG. 13 illustrates various possible types: (a) a polygonal split structure, (b) a stepped pattern added on top of the separated plates, and (c) a structure divided into two or more parts.

In the case of a stepped structure like in (b), the upper and lower plates interlock easily. These divided shapes only need to ensure that, during vertical stacking, the upper and lower plates interlock for alignment.

This invention pertains to a fuel cell stack that includes the modular structure described above.

By using the structure of the present invention, when a defect is detected within the fuel cell stack, it is possible to simply loosen the bolts and replace only the defective unit module 100, since the stack is composed of a vertically stacked modular structure. Furthermore, due to the self-aligning feature, reassembly is easy and precise.

Although the preferred embodiments of the present invention have been described in detail above, the scope of the invention is not limited to these embodiments. Various modifications and improvements based on the basic concept defined in the following claims by those skilled in the art also fall within the scope of the present invention.

What is claimed is:

1. A modular structure for a fuel cell stack, comprising:
a cell bundle (110) in which multiple fuel cells are stacked;
an upper plate (120) and a lower plate (130) positioned respectively above and below the cell bundle;
and side coupling members (140) and (150) coupled to both lateral sides of the upper and lower plates;
wherein the coupling of the side coupling members integrates the upper plate, the lower plate, the cell bundle positioned therebetween, and the side coupling members into a single module, such that the fuel cell stack can be disassembled on a per-module basis.

2. The module structure for a fuel cell stack according to claim 1,
wherein the side coupling member comprises:
dual end coupling grooves (152, 153) provided on upper portions of both ends and configured to be coupled to both side surfaces of the upper plate; and
a central coupling groove (155) provided on a lower central portion and configured to be coupled to a central side portion of the lower plate.

3. The module structure for a fuel cell stack according to claim 2,
wherein a first projection-recess portion is formed on an upper surface of the upper plate (120),
and a second projection-recess portion is formed on a lower surface of the lower plate (130), the second projection-recess portion being shaped to correspond to the first projection-recess portion and configured to engage therewith,
such that when module structures are stacked vertically, the first and second projection-recess portions of the upper and lower plates engage with each other to align the module structures.

4. The module structure for a fuel cell stack according to claim 2,
wherein the upper plate comprises upper sub-plates (120-1, 120-2) that are separated from each other to form a spaced region (120-3),
and the lower plate (130) is disposed in a region corresponding to the spaced region of the upper plates,
such that when the module structures are stacked vertically, the lower plate fits into the spaced region of the upper plate to achieve alignment.

5. The module structure for a fuel cell stack according to claim 1,
wherein the upper plate and the lower plate are conductive plates.

6. The module structure for a fuel cell stack according to claim 1,
wherein the fuel cell forming the cell bundle comprises a membrane electrode assembly (MEA), a gas diffusion layer, a gasket, and a separator.

7. A fuel cell stack comprising the module structure for a fuel cell stack according to claim 1.
